(19) United States
(12) Patent Application Publication
(10) Pub. No.: US 2026/0058260 A1
(43) Pub. Date: Feb. 26, 2026

(54) BATTERY CELL AND METHOD FOR MANUFACTURING THE SAME

(71) Applicant: SK ON CO., LTD., Seoul (KR)

(72) Inventors: Sin Young MOON, Daejeon (KR); Ji Hyung KIM, Daejeon (KR); Tae Hyeong KIM, Daejeon (KR); Bo Ra JEONG, Daejeon (KR); Soo Min JEONG, Daejeon (KR)

(21) Appl. No.: 19/307,042

(22) Filed: Aug. 22, 2025

(30) Foreign Application Priority Data
Aug. 22, 2024 (KR) 10-2024-0112851

(51) Int. Cl. H01M 50/126; H01M 10/04; H01M 50/105

(52) U.S. Cl. CPC H01M 50/126; H01M 10/049; H01M 50/105

(57) ABSTRACT

A battery cell according to the present disclosure may include an electrode assembly, a pouch formed of a pouch sheet and including a receiving part configured to accommodate the electrode assembly, and a curing agent, wherein the pouch may be formed of the pouch sheet and includes a folding part including a first folding bonding part and a second folding bonding part, which face and are in contact with each other, the folding part may include a folding body extending from the receiving part, and a folding tail extending from the folding body and folded to face the folding body, and the folding body may be bent so that the curing agent is disposed between the folding tail and the receiving part.

### CROSS-REFERENCE TO RELATED APPLICATION

This patent application claims the priority and benefits of Korean patent application No. 10-2024-0112851, filed on Aug. 22, 2024, the disclosure of which is incorporated herein by reference in its entirety.

### BACKGROUND OF THE INVENTION

### 1. Field of the Invention

The present disclosure relates to a battery cell and a method for manufacturing the same.

### 2. Description of the Related Art

In the case of a battery cell using a pouch, when thermal runaway occurs, gas may be concentrated in a portion of the pouch that is folded. In addition, if the folded portion of the pouch is unfolded or compressed, the insulation of the battery cell may be damaged. Therefore, it is necessary to effectively seal the folded portion of the pouch.

### SUMMARY OF THE INVENTION

It is an object of the present disclosure to provide a battery cell in which the sealing of the folded portion of the pouch is enhanced by using a curing agent, and a method for manufacturing the same.

A battery cell according to the present disclosure may include: an electrode assembly; a pouch formed of a pouch sheet and including a receiving part configured to accommodate the electrode assembly; and a curing agent, wherein the pouch may be formed of the pouch sheet and includes a folding part including a first folding bonding part and a second folding bonding part, which face and are in contact with each other, the folding part may include a folding body extending from the receiving part, and a folding tail extending from the folding body and folded to face the folding body, and the folding body may be bent so that the curing agent is disposed between the folding tail and the receiving part.

The pouch sheet may include a pouch inner surface and a pouch outer surface, and the pouch inner surface at the first folding bonding part may be bonded to the pouch inner surface at the second folding bonding part.

The pouch sheet may include: an inner layer forming the pouch inner surface; an outer layer forming the pouch outer surface; and a middle layer located between the inner layer and the outer layer, wherein the inner layer, the middle layer and the outer layer may be sequentially stacked.

The receiving part may be formed of the pouch sheet, and may include a first receiving part and a second receiving part, which extend in a longitudinal direction and are spaced apart from each other in a width direction, and the pouch may be formed of the pouch sheet, and may include a connection part configured to connect the first receiving part and the second receiving part, the connection part extending from the first receiving part and continuing to the second receiving part.

The first folding bonding part may extend in the width direction from the first receiving part, and the second folding bonding part may extend in the width direction from the second receiving part.

The electrode assembly may be located between the folding part and the connection part.

The pouch may include: a first lead bonding part formed of the pouch sheet and extending in the longitudinal direction from the first receiving part; and a second lead bonding part formed of the pouch sheet, extending in the longitudinal direction from the second receiving part, and bonded to the first lead bonding part.

The battery cell may further include an electrode lead extending in the longitudinal direction from the electrode assembly, and the electrode lead may be located between the first lead bonding part and the second lead bonding part.

The curing agent may be cured by irradiation with ultraviolet light.

The curing agent may be cured by receiving a pressure of 280 kPa to 300 kPa.

A method for manufacturing a battery cell according AH the present disclosure may include the steps of: accommodating an electrode assembly in a receiving part of a pouch formed of a pouch sheet, folding the pouch, and bonding a first folding bonding part and a second folding bonding part, which extend from the receiving part, to seal the pouch; and bonding the folding part, formed by bonding the first folding bonding part and the second folding bonding part, using a curing agent.

The folding part may include a folding body extending from the receiving part, and a folding tail extending from the folding body, the step of bonding the folding part may include a first folding part folding step of folding the folding tail so that the folding tail faces the folding body.

The step of bonding the folding part may include a second folding part folding and curing agent application step of bending the folded folding part so that the folded folding part faces the receiving part, and the curing agent is disposed between the folding part and the receiving part.

The curing agent may be disposed between the folding tail and the receiving part.

The step of bonding the folding part may include a curing step of curing the curing agent.

In the curing step, a pressure of 280 kPa to 300 kPa may be applied to the curing agent.

In the curing step, ultraviolet light may be irradiated onto the curing agent.

In the curing step, the curing agent may be maintained at a temperature of 180° C. to 200° C.

The receiving part may include a first receiving part and a second receiving part, which extend in a longitudinal direction and are spaced apart from each other in a width direction, the first folding bonding part may extend in the width direction from the first receiving part, and the second folding bonding part may extend in the width direction from the second receiving part.

The pouch may further include a connection part configured to connect the first receiving part and the second receiving part, the connection part extending from the first receiving part and continuing to the second receiving part, and the electrode assembly may be located between the connection part and the folding part.

According to an embodiment of the present disclosure, a battery cell having enhanced sealing at the folded portion of the pouch using a curing agent, and a method for manufacturing the same, may be provided.

The battery cell and the method for manufacturing the same of the present disclosure may be used in eco-friendly electric vehicles, hybrid vehicles, and the like, which are aimed at mitigating climate change by reducing air pollution and greenhouse gas emissions.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a view illustrating a pouch sheet;

FIG. 2 is a cross-sectional view of the pouch sheet shown in FIG. 1, taken along line A1-A2;

FIG. 3 is a view illustrating a state in which the pouch sheet shown in FIG. 1 is processed into a pouch;

FIG. 4 is a cross-sectional view of the pouch shown in FIG. 3, taken along line B1-B2;

FIG. 5 is a view illustrating a battery cell according to an embodiment of the present disclosure;

FIG. 6 is a cross-sectional view of the battery cell shown in FIG. 5, taken along line C1-C2;

FIG. 7 is an enlarged view of Area D shown in FIG. 6, illustrating a state in which a folding tail is bent from a folding body;

FIG. 8 is a view illustrating a state in which the folding part shown in FIG. 7 is folded;

FIG. 9 is a view illustrating a state in which the folding part shown in FIG. 8 is bent toward a receiving part and a curing agent is disposed between the folding part and the receiving part;

FIG. 10 is a table illustrating experimental results for curing the curing agent shown in FIG. 9 under different pressure conditions;

FIG. 11 is a flowchart illustrating a method for manufacturing a battery cell according to an embodiment of the present disclosure;

FIG. 12 is a flowchart illustrating a folding part bonding step; and

FIG. 13 is a table illustrating the state of the battery cell depending on the ratio of the curing agent applied as shown in FIG. 9.

### DETAILED DESCRIPTION OF THE INVENTION

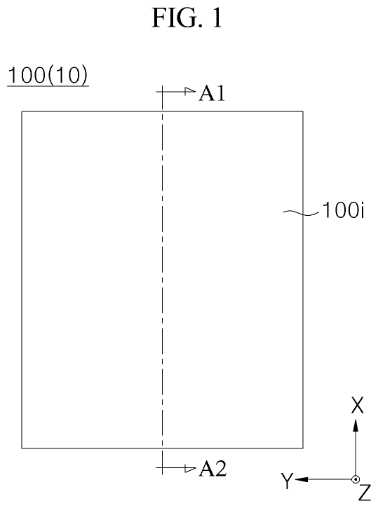

Hereinafter, embodiments of the present disclosure will be described in detail with reference to FIGS. 1 to 13. However, these embodiments are merely for illustrative, and the present disclosure is not limited to the specific embodiments described as examples.

An XYZ coordinate system may be used in this specification. The XYZ coordinate system may be a Cartesian coordinate system.

For example, the Z-axis may be parallel to the up-down direction. For instance, a positive Z-axis direction may represent the upward direction, and a negative Z-axis direction may represent the downward direction.

For example, the X-axis may be parallel to the front-rear direction. For instance, a positive X-axis direction may represent the forward direction, and a negative X-axis direction may represent the rearward direction.

For example, the Y-axis may be parallel to the left-right direction. For instance, a positive Y-axis may represent the leftward direction, and a negative Y-axis may represent the rightward direction.

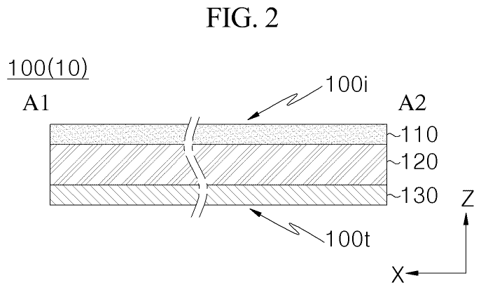

FIG. 1 is a view illustrating a pouch sheet. FIG. 2 is a cross-sectional view of the pouch sheet shown in FIG. 1, taken along line A1-A2. A battery pouch 10 may be referred to as a “pouch.”

Referring to FIGS. 1 and 2, the battery pouch 10 may include a pouch sheet 100. For example, the battery pouch 10 may be formed by processing the pouch sheet 100. For example, the battery pouch 10 may be formed by press-processing the pouch sheet 100.

The pouch sheet 100 may have a sheet shape. For example, the pouch sheet 100 may have a planar shape before being processed. For example, the pouch sheet 100 may have two sides.

For example, a pouch inner surface 100i may be one side of the pouch sheet 100. For example, a pouch outer surface 100t may be the opposite side of the pouch sheet 100. The thickness of the pouch sheet 100 may be the distance between the pouch inner surface 100i and the pouch outer surface 100t.

The pouch sheet 100 may have a structure in which a plurality of layers are stacked. For example, the pouch sheet 100 may have a laminated structure in which an inner layer 110, a middle layer 120 and an outer layer 130 are stacked.

For example, the pouch sheet 100 may include the inner layer 110. The inner layer 110 may form the pouch inner surface 100i. The inner layer 110 may be folded to overlap itself and heat-bonded.

The inner layer 110 may be formed of an electrically insulating material. For example, the inner layer 110 may be formed of a material containing polypropylene (PP).

The pouch sheet 100 may include the outer layer 130. The outer layer 130 may form the pouch outer surface 100t. The outer layer 130 may be formed of a material that is waterproof and electrically insulating. For example, the outer layer 130 may be formed of a material containing polycarbonate (PC).

The pouch sheet 100 may include the middle layer 120. The middle layer 120 may be located between the inner layer 110 and the outer layer 130.

The middle layer 120 may have rigidity. For example, the middle layer 120 may be formed of a metallic material. For example, the middle layer 120 may retain its shape.

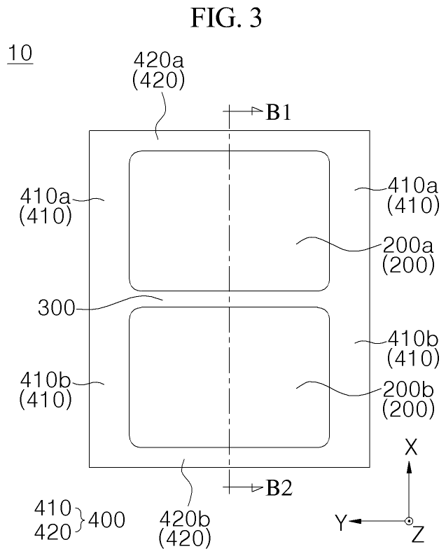

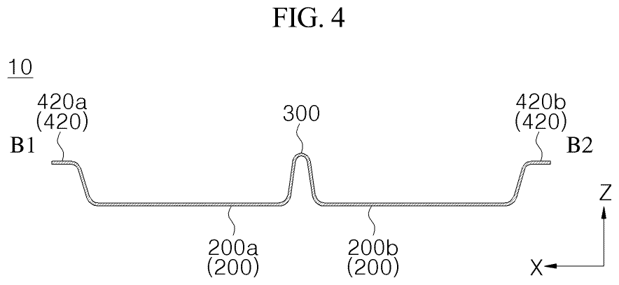

FIG. 3 is a view illustrating a state in which the pouch sheet shown in FIG. 1 is processed into a pouch. FIG. 4 is a cross-sectional view of the pouch shown in FIG. 3, taken along line B1-B2.

Referring to FIGS. 1 to 4, the pouch sheet 100 shown in FIG. 1 may be press-processed. When the pouch sheet 100 (see FIG. 1) is press-processed, the shape of the pouch sheet 100 (see FIG. 1) may be retained after being deformed.

The pouch 10 may include a receiving part 200. A plurality of receiving parts 200 may be provided. For example, the pouch 10 may include a first receiving part 200a and a second receiving part 200b. The receiving part 200 may include or refer to at least one of the first receiving part 200a and the second receiving part 200b.

The pouch inner surface 100i of the receiving part 200 may be concave, and the pouch outer surface 100t of the receiving part 200 may be convex. The receiving part 200 may accommodate an electrode assembly (not shown). For example, the pouch inner surface 100i at the receiving part 200 may face the electrode assembly (not shown).

The receiving part 200 may have a shape extending in one direction. For example, the extension direction of the receiving part 200 may be the longitudinal direction of the receiving part 200. For example, the longitudinal direction of the receiving part 200 may correspond to the left-right direction. For example, the longitudinal direction of the receiving part 200 may correspond to the Y-axis direction.

For example, the width direction of the receiving part 200 may intersect the longitudinal direction of the receiving part 200. For example, the width direction of the receiving part 200 may correspond to the front-back direction. For example, the width direction of the receiving part 200 may correspond to the X-axis direction. The first receiving part 200a and the second receiving part 200b may be arranged in the width direction.

The pouch 10 may include a connection part 300. The connection part 300 may be located between the first receiving part 200a and the second receiving part 200b. The connection part 300 may connect the first receiving part 200a and the second receiving part 200b. The pouch inner surface 100i at the connection part 300 may be convex, and the pouch outer surface 100t at the connection part 300 may be concave.

The pouch 10 may include a bonding part 400. A plurality of bonding parts 400 may be provided. For example, the pouch 10 may include a lead bonding part 410 and a folding bonding part 420. The bonding part 400 may include or refer to at least one of the lead bonding part 410 and the folding bonding part 420.

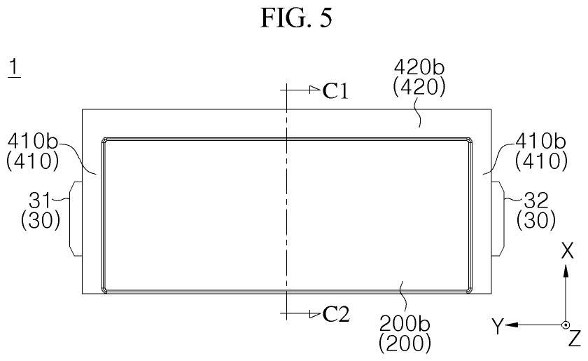

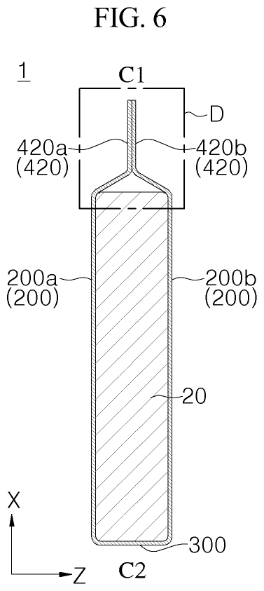

The lead bonding part 410 may be formed to extend from the receiving part 200 in the longitudinal direction of the receiving part 200. When an electrode assembly 20 (see FIG. 6) is accommodated in the receiving part 200, the lead bonding part 410 may come into contact with an electrode lead 30 (see FIG. 5) protruding from the electrode assembly 20 (see FIG. 6).

For example, a first lead bonding part 410a may be formed to extend from the first receiving part 200a in the longitudinal direction of the first receiving part 200a. For example, a second lead bonding part 410b may be formed to extend from the second receiving part 200b in the longitudinal direction of the second receiving part 200b. The lead bonding part 410 may include or refer to at least one of the first lead bonding part 410a and the second lead bonding part 410b.

For example, the folding bonding part 420 may extend in the width direction from the receiving part 200 and may continue to the perimeter of the pouch sheet 100. The width direction may intersect the longitudinal direction. For example, the width direction may be parallel to the direction from the first receiving part 200a toward the second receiving part 200b.

For example, the first folding bonding part 420a may extend in the width direction from the first receiving part 200a and may continue to the perimeter of the pouch sheet 100. For example, the second folding bonding part 420b may extend in the width direction from the second receiving part 200b and may continue to the perimeter of the pouch sheet 100.

The folding bonding part 420 may include or refer to at least one of the first folding bonding part 420a and the second folding bonding part 420b. The first folding bonding part 420a, the first receiving part 200a, the second receiving part 200b, and the second folding bonding part 420b may be sequentially arranged.

FIG. 5 is a view illustrating a battery cell according to an embodiment of the present disclosure. FIG. 6 is a cross-sectional view of the battery cell shown in FIG. 5, taken along line C1-C2.

Referring to FIGS. 5 and 6, the thickness of a battery cell 1 may correspond to the distance between the first receiving part 200a and the second receiving part 200b. For example, the thickness of the battery cell 1 may be the length of the battery cell 1 based on the thickness direction of the battery cell 1.

The thickness direction of the battery cell 1 may be parallel to the direction from the first receiving part 200a toward the second receiving part 200b. For example, the thickness direction of the battery cell 1 may be parallel to the Z-axis.

After the electrode assembly 20 is seated and accommodated in the first receiving part 200a, the pouch 10 (see FIGS. 3 and 4) may be bent and folded at the connection part 300. When the pouch 10 (see FIGS. 3 and 4) is folded, the pouch 10 (see FIGS. 3 and 4) may be folded to overlap itself.

The pouch inner surfaces 100i (see FIG. 2) of the folded pouch 10 (see FIGS. 3 and 4) may face each other. The pouch inner surfaces 100i (see FIG. 2) of the folded pouch 10 (see FIGS. 3 and 4) may be bonded to each other. For example, the folded pouch 10 (see FIGS. 3 and 4) may be bonded and sealed.

For example, the first lead bonding part 410a (see FIG. 3) and the second lead bonding part 410b (see FIG. 3) may be bonded to each other while facing each other. For example, the first folding bonding part 420a and the second folding bonding part 420b may be bonded to each other while facing each other.

The electrode lead 30 may protrude in the longitudinal direction from the electrode assembly 20. For example, the electrode lead 30 may be fused to an electrode tab (not shown) protruding in the longitudinal direction from the electrode assembly 20. For example, the electrode lead 30 may be connected to the electrode assembly 20 via the electrode tab (not shown).

The electrode lead 30 may penetrate through the lead bonding part 410. For example, the electrode lead 30 may pass between the first lead bonding part 410a (see FIG. 3) and the second lead bonding part 410b (see FIG. 3).

The electrode lead 30 may include or refer to at least one of the left electrode lead 31 and the right electrode lead 32. The left electrode lead 31 may protrude to the left from the electrode assembly 20. The right electrode lead 32 may protrude to the right from the electrode assembly 20.

When the first folding bonding part 420a and the second folding bonding part 420b are bonded together, the folding bonding part 420 may be referred to as a “folding part.” The folding part 420 may be located on the side opposite the connection part 300. For example, the electrode assembly 20 may be located between the folding part 420 and the connection part 300.

In a battery module (not shown) in which a plurality of battery cells 1 are arranged, the connection part 300 may be in contact with a bottom surface of the battery module (not shown). In this case, when thermal runaway occurs in the battery cell 1, heat and gas may be concentrated in the folding part 420. Therefore, it is necessary to maintain the bonding strength between the first folding bonding part 420a and the second folding bonding part 420b of the folding part 420.

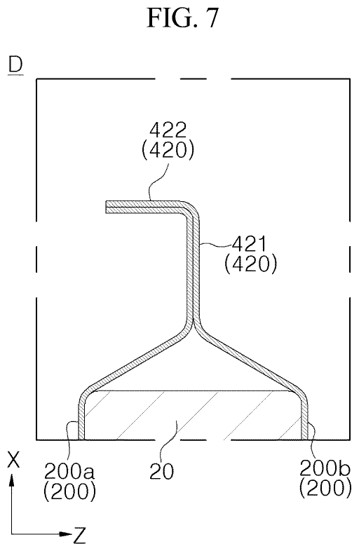

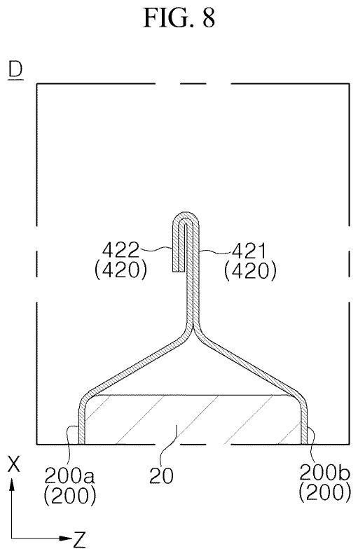

FIG. 7 is an enlarged view of Area D shown in FIG. 6, illustrating a state in which a folding tail is bent from a folding body. FIG. 8 is a view illustrating a state in which the folding part shown in FIG. 7 is folded.

Referring to FIG. 6 to FIG. 8, the folding part 420 may be divided into two regions. For example, the folding part 420 may include a folding body 421 extending from the receiving part 200.

For example, the folding part 420 may include a folding tail 422 extending from the folding body 421. The folding part 420 may be bent at the boundary between the folding body 421 and the folding tail 422. For example, the folding part 420 may be bent toward the first receiving part 200a at the boundary between the folding body 421 and the folding tail 422.

When the folding part 420 is further bent, the folding part 420 may be folded. For example, the folding body 421 and the folding tail 422 may be positioned to face each other. For example, the first folding bonding part 420a of the folding body 421 and the first folding bonding part 420a of the folding tail 422 may face each other.

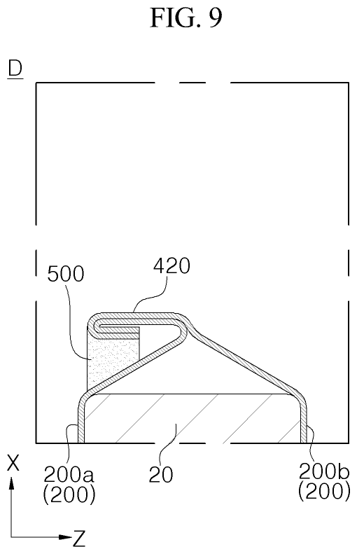

FIG. 9 is a view illustrating a state in which the folding part shown in FIG. 8 is bent toward the receiving part and a curing agent is disposed between the folding part and the receiving part.

Referring to FIGS. 8 and 9, the folding part 420 may be bent toward the receiving part 200. For example, the folding part 420 may be bent toward the first receiving part 200a.

When the folding part 420 is bent toward the receiving part 200, the folding tail 422 may face the receiving part 200. For example, when the folding part 420 is bent toward the first receiving part 200a, the folding tail 422 may face the first receiving part 200a.

A curing agent 500 may be disposed between the folding part 420 and the receiving part 200. For example, the curing agent 500 may be disposed between the folding tail 422 and the receiving part 200. For instance, the curing agent 500 may be disposed between the folding tail 422 and the first receiving part 200a.

Ultraviolet (UV) rays may be irradiated onto the curing agent 500. During the exposure of the curing agent 500 to UV rays, at least one of heat and pressure may be applied to the curing agent 500. For example, at least one of heat and pressure may be applied to the folding part 420. Through this process, the folding part 420 may be fixed to the receiving part 200.

Referring to FIGS. 5 and 9, the curing agent 500 may be distributed along the longitudinal direction of the battery cell 1. The longitudinal direction of the battery cell 1 may correspond to the longitudinal direction of the receiving part 200. In this way, the portion formed by the curing agent 500 may be referred to as a “curing region.”

For example, the curing region 500 may be distributed along the boundary between the receiving part 200 and the folding part 420. For example, the curing region 500 formed by the curing agent 500 may be integrally formed. For example, the curing region 500 may extend from one end of the boundary between the receiving part 200 and the folding part 420 and may continue to the other end.

Alternatively, the curing region 500 may be formed of a plurality of discrete curing regions 500. For example, the plurality of curing regions 500 may be spaced apart from each other and sequentially arranged along the longitudinal direction of the battery cell 1.

For example, based on the longitudinal direction of the battery cell 1, the total length of the plurality of curing regions 500 may be 40% to 60% of the length of the receiving part 200. For example, based on the longitudinal direction of the battery cell 1, the total length of the plurality of curing regions 500 may be 50% of the length of the receiving part 200. Accordingly, while maintaining an appropriate amount of the curing agents 500, the bonding strength between the folding part 420 and the receiving part 200 may be maintained through the curing agents 500.

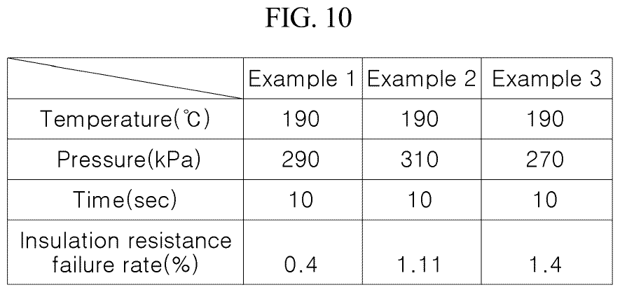

FIG. 10 is a table illustrating experimental results for curing the curing agent shown in FIG. 9 under different pressure conditions.

Referring to FIGS. 9 and 10, the curing agent 500 may be cured under the conditions of Examples 1 to 3. The curing agent 500 may be irradiated with ultraviolet (UV) light. The curing agent 500 may be cured at a temperature of 190° C. for 10 seconds.

According to Example 1, the curing agent 500 may be cured at a pressure of 290 kPa. According to Example 2, the curing agent 500 may be cured at a pressure of 310 kPa. According to Example 3, the curing agent 500 may be cured at a pressure of 270 kPa.

When the curing agent 500 is cured under the conditions of Example 1, the insulation resistance failure rate of the battery cell 1 (see FIG. 5) may be 0.4%. When the curing agent 500 is cured under the conditions of Example 2, the insulation resistance failure rate of the battery cell 1 (see FIG. 5) may be 1.11%. When the curing agent 500 is cured under the conditions of Example 3, the insulation resistance failure rate of the battery cell 1 (see FIG. 5) may be 1.4%.

When the pressure applied to the curing agent 500 is in the range of 280 kPa to 300 kPa, it can be confirmed that the battery cell 1 (see FIG. 5) exhibits excellent quality based on the insulation resistance failure rate.

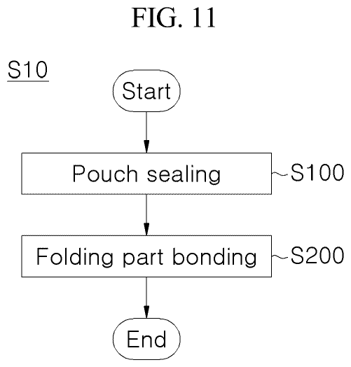

FIG. 11 is a flowchart illustrating a method for manufacturing a battery cell according to an embodiment of the present disclosure.

Referring to FIGS. 1 to 11, a battery cell manufacturing method (S10) may include a pouch sealing step (S100). In step S100, the electrode assembly 20 may be accommodated in the receiving part 200. In step S100, the pouch 10 may be folded.

In step S100, the first bonding parts 410a and 420a and the second bonding parts 410b and 420b may be positioned to face each other. For example, the pouch inner surface 100i of the first bonding parts 410a and 420a and the pouch inner surface 100i of the second bonding parts 410b and 420b may face each other.

The first bonding parts 410a and 420a may include or refer to at least one of the first lead bonding part 410a and the first folding bonding part 420a. The second bonding parts 410b and 420b may include or refer to at least one of the second lead bonding part 410b and the second folding bonding part 420b.

For example, in step S100, the first lead bonding part 410a and the second lead bonding part 410b may be bonded while facing each other. For example, in step S100, the first folding bonding part 420a and the second folding bonding part 420b may be bonded while facing each other. As a result, the pouch 10 may be sealed.

The battery cell manufacturing method (S10) may include a folding part bonding step (S200). In step S200, the folding part 420 may be folded and bonded using the curing agent 500.

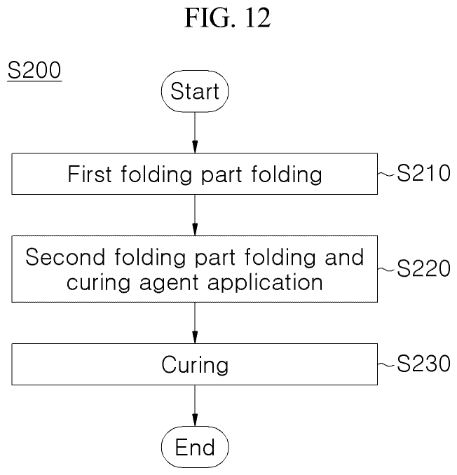

FIG. 12 is a flowchart illustrating the folding part bonding step.

Referring to FIGS. 1 to 12, the folding part bonding step (S200) may include a first folding part folding step (S210). In step S210, the folding tail 422 may be bent from the folding body 421 and folded. For example, in step S210, at the boundary between the folding tail 422 and the folding body 421, the folding part 420 may be bent and folded toward the first receiving part 200a.

The folding part bonding step (S200) may include a second folding part folding and curing agent application step (S220). In step S220, the folded folding part 420 may be bent toward the receiving part 200. For example, in step S220, the folded folding part 420 may be further bent in its folding direction, so that the folding part 420 faces the receiving part 200.

For example, in step S220, the folding part 420 folded toward the first receiving part 200a may be further bent toward the first receiving part 200a to face the first receiving part 200a.

For example, in step S220, the curing agent 500 may be applied between the folded folding part 420 and the receiving part 200. Alternatively, in step S220, after the curing agent 500 is applied to at least one of the folding part 420 and the receiving part 200 in the folded state, the folding part 420 may be bent to face the receiving part 200.

For example, in step S220, the folding body 421, the folding tail 422, the curing agent 500 and the receiving part 200 may be sequentially arranged. For example, the folding tail 422 may be located between the folding body 421 and the curing agent 500.

The folding part bonding step (S200) may include a step (S230) of curing the curing agent 500. In step S230, the curing agent 500 may be irradiated with ultraviolet (UV) light.

In step S230, a pressure of 280 kPa to 300 kPa may be applied to the curing agent 500 at a temperature of 180° C. to 200° C. for 9 to 11 seconds. In step S230, the curing agent 500 may be cured, so that the folding part 420 may be fixed to the receiving part 200 through the curing agent 500.

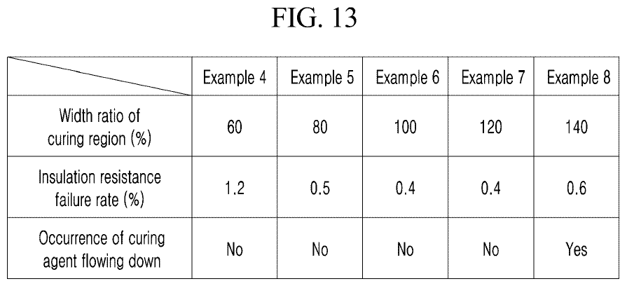

FIG. 13 is a table illustrating the state of the battery cell depending on the ratio of the curing agent applied as shown in FIG. 9.

Referring to FIGS. 9 and 13, the applied ratio of the curing region 500 or the width ratio of the curing region 500 may be expressed as a percentage representing the width of the curing region 500 relative to the width of the folding tail 422.

According to Examples 4 to 8, the curing agent 500 may be irradiated with ultraviolet (UV) light at a temperature of 190° C. for 10 seconds. According to Examples 4 to 8, the curing agent 500 may be cured at a pressure of 290 kPa.

The width of the curing region 500 may refer to the length of the curing region 500 based on the thickness direction of the battery cell 1 (see FIG. 6). The width of the folding tail 422 may refer to the length of the folding tail 422 based on the direction in which the folding tail 422 extends from the folding body 421.

The width of the curing region 500 may be set based on the width of the folding tail 422. For example, as in Example 6, the width of the curing region 500 may be 100% of the width of the folding tail 422.

For example, as in Example 4, the width of the curing region 500 may be 60% of the width of the folding tail 422. In this case, the bonding strength between the folding tail 422 and the receiving part 200 may be relatively low, so that the insulation resistance failure rate may be as high as 1.2.

For example, as in Example 5, the width of the curing region 500 may be 80% of the width of the folding tail 422. In this case, the insulation resistance failure rate may be 0.5, which is relatively low, compared to when the width of the curing region 500 is 60% of the width of the folding tail 422.

For example, as in Example 8, the width of the curing region 500 may be 140% of the width of the folding tail 422. In this case, some of the curing agent 500 forming the curing region 500 may not be affected by ultraviolet light.

The curing agent 500, which is not affected by ultraviolet light, may not effectively bond the folding part 420 and the receiving part 200. In addition, the uncured curing agent 500 may flow down in an uncured state. If the curing agent 500 flows out, the quality of the battery cell 1 (see FIG. 6) may deteriorate. For example, according to Example 8, the insulation resistance failure rate of the battery cell 1 may be 0.6, which is higher than that in Examples 6 and 7.

For example, as in Example 7, the width of the curing region 500 may be 120% of the width of the folding tail 422. In this case, the curing agent 500 may not flow down, and the insulation resistance failure rate of the battery cell 1 may be 0.4, which is relatively low.

Therefore, when the width of the curing region 500 is 80% to 120% of the width of the folding tail 422, the curing region 500 may effectively bond the folding part 420 and the receiving part 200, and the insulation resistance failure rate may be relatively low. In addition, when the width of the curing region 500 is 80% to 120% of the width of the folding tail 422, the curing agent 500 forming the curing region 500 may be prevented from flowing down.

The contents described above are merely examples of applying the principles of the present disclosure, and other configurations may be further included without departing from the scope of the present disclosure.

What is claimed is:

1. A battery cell comprising:
an electrode assembly;
a pouch formed of a pouch sheet and comprising a receiving part configured to accommodate the electrode assembly, and
a curing agent,
wherein the pouch is formed of the pouch sheet and comprises a folding part including a first folding bonding part and a second folding bonding part, which face and are in contact with each other,
wherein the folding part comprises a folding body extending from the receiving part, and a folding tail extending from the folding body and folded to face the folding body, and
wherein the folding body is bent so that the curing agent is disposed between the folding tail and the receiving part.

2. The battery cell according to claim 1, wherein the pouch sheet includes a pouch inner surface and a pouch outer surface, and
wherein the pouch inner surface at the first folding bonding part is bonded to the pouch inner surface at the second folding bonding part.

3. The battery cell according to claim 2, wherein the pouch sheet comprises:
an inner layer forming the pouch inner surface;
an outer layer forming the pouch outer surface; and
a middle layer located between the inner layer and the outer layer,
wherein the inner layer, the middle layer and the outer layer are sequentially stacked.

4. The battery cell according to claim 1, wherein the receiving part is formed of the pouch sheet, and comprises a first receiving part and a second receiving part, which extend in a longitudinal direction and are spaced apart from each other in a width direction, and
wherein the pouch is formed of the pouch sheet, and comprises a connection part configured to connect the first receiving part and the second receiving part, the connection part extending from the first receiving part and continuing to the second receiving part.

5. The battery cell according to claim 4, wherein the first folding bonding part extends in the width direction from the first receiving part, and
wherein the second folding bonding part extends in the width direction from the second receiving part.

6. The battery cell according to claim 5, wherein the electrode assembly is located between the folding part and the connection part.

7. The battery cell according to claim 6, wherein the pouch comprises:
a first lead bonding part formed of the pouch sheet and extending in the longitudinal direction from the first receiving part; and
a second lead bonding part formed of the pouch sheet, extending in the longitudinal direction from the second receiving part, and bonded to the first lead bonding part.

8. The battery cell according to claim 7, further comprising an electrode lead extending in the longitudinal direction from the electrode assembly, and
wherein the electrode lead is located between the first lead bonding part and the second lead bonding part.

9. The battery cell according to claim 1, wherein the curing agent is cured by irradiation with ultraviolet light.

10. The battery cell according to claim 9, wherein the curing agent is cured by receiving a pressure of 280 kPa to 300 kPa.

11. A method for manufacturing a battery cell comprising the steps of:
accommodating an electrode assembly in a receiving part of a pouch formed of a pouch sheet, folding the pouch, and bonding a first folding bonding part and a second folding bonding part, which extend from the receiving part, to seal the pouch; and
bonding the folding part, formed by bonding the first folding bonding part and the second folding bonding part, using a curing agent.

12. The method for manufacturing a battery cell according to claim 11, wherein the folding part comprises a folding body extending from the receiving part, and a folding tail extending from the folding body,
wherein the step of bonding the folding part comprises a first folding part folding step of folding the folding tail so that the folding tail faces the folding body.

13. The method for manufacturing a battery cell according to claim 12, wherein the step of bonding the folding part comprises a second folding part folding and curing agent application step of bending the folded folding part so that the folded folding part faces the receiving part, and the curing agent is disposed between the folding part and the receiving part.

14. The method for manufacturing a battery cell according to claim 13, wherein the curing agent is disposed between the folding tail and the receiving part.

15. The method for manufacturing a battery cell according to claim 13, wherein the step of bonding the folding part comprises a curing step of curing the curing agent.

16. The method for manufacturing a battery cell according to claim 15, wherein, in the curing step, a pressure of 280 kPa to 300 kPa is applied to the curing agent.

17. The method for manufacturing a battery cell according to claim 16, wherein, in the curing step, ultraviolet light is irradiated onto the curing agent.

18. The method for manufacturing a battery cell according to claim 17, wherein, in the curing step, the curing agent is maintained at a temperature of 180° C. to 200° C.

19. The method for manufacturing a battery cell according to claim 13, wherein the receiving part comprises a first receiving part and a second receiving part, which extend in a longitudinal direction and are spaced apart from each other in a width direction,
wherein the first folding bonding part extends in the width direction from the first receiving part, and
wherein the second folding bonding part extends in the width direction from the second receiving part.

20. The method for manufacturing a battery cell according to claim 19, wherein the pouch further comprises a connection part configured to connect the first receiving part and the second receiving part, the connection part extending from the first receiving part and continuing to the second receiving part, and
wherein the electrode assembly is located between the connection part and the folding part.
